(19) United States
(12) Patent Application Publication
(10) Pub. No.: US 2026/0050201 A1
(43) Pub. Date: Feb. 19, 2026

(54) HUNTING CAMERA

(71) Applicant: Dongguan HDKing Smart Technology Co.,LTD., Dongguan (CN)

(72) Inventors: BOLIN HAN, Dongguan (CN); YONGCHUN REN, Dongguan (CN)

(21) Appl. No.: 18/813,524

(22) Filed: Aug. 23, 2024

(30) Foreign Application Priority Data
Aug. 13, 2024 (CN) 202421959376.0

(51) Int. Cl. G03B 7/26

(52) U.S. Cl. CPC G03B 7/26

(57) ABSTRACT

A hunting camera includes a camera main body, a solar device and a sealing element, wherein the camera main body includes an upper shell and a lower shell, the upper shell and the lower shell are fixedly closed, a previous gap after the upper shell and the lower shell are closed is sealed by the sealing element so as to form a sealing cavity after the upper shell and the lower shell are mutually closed, the solar device is arranged on the top of the upper shell or the top of the lower shell, and the solar device and the upper shell or the lower shell are integrally arranged. Through the arrangement of the solar device, light energy is converted into electric energy by the solar device for supplying power for the hunting camera to reduce the situation of insufficiency in power supply.

### CROSS-REFERENCE TO RELATED APPLICATIONS

The application claims priority of Chinese patent application CN2024219593760, filed on 2024 Aug. 13, which is incorporated herein by reference in its entireties.

### TECHNICAL FIELD

The present disclosure relates to a camera, in particular to a hunting camera applied to the technical field of hunting accessories.

### BACKGROUND

The hunting camera, also known as a shooting camera, is a special camera. The hunting camera is an unattended camera that can automatically capture the motion state of people or animals in the wild. The hunting camera is in a dormant state by default. Only when people or animals move into the shooting sight of the camera through pyroelectric infrared detection, the camera is quickly started for continuous capturing or video recording. The hunting camera is convenient for hunters or observers to understand the moving directions of prey.

However, the existing hunting camera needs battery replacement or charging after being used for a long time. That is to say, the hunting camera cannot be used for a long time. However, desired pictures are not captured at this moment. No matter the hunting camera needs battery replacement or charging, the hunting camera needs to be detached from the fixed position and then is fixed to the original position. Long time of the user needs to be wasted if the camera is charged. Battery replacement is extremely troublesome if the standby battery is free of electricity. Thus, the use of the user is seriously influenced, which is troublesome to the user.

### SUMMARY

In view of the troublesome problems mentioned in the prior art that the hunting camera cannot be used for a long time, and the hunting camera needs to be disassembled and then reinstalled and refixed by replacing the battery or charging, the problems are troublesome to the user. The present disclosure provides a hunting camera. Through the arrangement of the solar device, light energy is converted into electric energy by the solar device for supplying power for the hunting camera to reduce the situation of insufficiency in power supply. The hunting camera does not need to be disassembled frequently for battery replacement or charging. Through the integral arrangement of the solar device and the upper shell or the lower shell, the hunting camera is small and convenient for the user to carry. The gap between the upper shell and the lower shell is sealed by the sealing ring after the upper shell and the lower shell are closed, so that the hunting camera can be used in various environmental situations.

The technical solution adopted by the present disclosure to solve the technical problem is as follows.

A hunting camera includes a camera main body, a solar device and a sealing element, wherein the camera main body includes an upper shell and a lower shell, the upper shell and the lower shell are fixedly closed, a previous gap after the upper shell and the lower shell are closed is sealed by the sealing element so as to form a sealing cavity after the upper shell and the lower shell are mutually closed, the solar device is arranged on the top of the upper shell or the top of the lower shell, and the solar device and the upper shell or the lower shell are integrally arranged.

Further, the sealing element is a sealing ring, a mounting groove is formed in a side wall inside the upper shell or the lower shell, the mounting groove is arranged around an opening of the upper shell or an opening of the lower shell, the sealing ring is mounted inside the mounting groove, a clamping groove is formed in a side surface, facing towards the mounting groove, of the sealing ring, and the clamping groove is clamped to a side wall, away from the camera main body, of the mounting groove.

Further, the hunting camera also includes a first fixed part, first mounting columns are arranged on the periphery of the upper shell internally, a first mounting hole is formed in an end head of one end, facing towards the lower shell, of the first mounting column, second mounting columns are arranged on the periphery of the lower shell internally and arranged corresponding to the first mounting columns, a second mounting hole is formed in an end head of one end, facing towards the upper shell, of the second mounting column, the sealing ring is provided with connecting pieces corresponding to the first mounting columns and the second mounting columns, a third mounting hole corresponding to the first mounting hole and the second mounting hole is formed in the connecting piece, and the first fixed part passes through the second mounting hole, the third mounting hole and the first mounting hole in sequence so that the lower shell and the sealing ring are fixed to the upper shell.

Further, the hunting camera also includes a storage battery, supports are arranged at both ends of an inner side surface of the upper shell, and both ends of the storage battery are respectively placed on the two supports.

Further, the hunting camera also includes a control circuit board, the solar device and the storage battery are both electrically connected with the control circuit board, the control circuit board is arranged inside the sealing cavity, and the control circuit board is located below the storage battery and gets away from the lower shell.

Further the hunting camera also includes a sensor, a plurality of functional buttons, a lens component, light components, a display screen and an indicator light, the sensor, the functional buttons, the lens component, the light components, the display screen and the indicator light are all arranged on a front face of the camera main body, the sensor, the lens component and the display screen are arranged towards the bottom of the camera main body in sequence from approaching the top of the camera main body, the functional buttons are distributed and arranged on both sides of the sensor, the light components are distributed and arranged on both sides of the lens component, and the indicator light is arranged on one side of the display screen.

Further, the control circuit board includes a first circuit board and a second circuit board, the first circuit board and the second circuit board are stacked and electrically connected, an opening is formed in the second circuit board, one end of the lens component is mounted on the first circuit board, the other end of the lens component passes through the opening to be mounted on the front face of the camera main body, and the functional buttons, the lens component, the light components, the display screen and the indicator light are connected with the first circuit board.

Further, the hunting camera also includes a charging connector, the charging connector is connected with the first circuit board, and the charging connector is located on a side face of the camera main body.

Further, the hunting camera also includes a microphone, the microphone is electrically connected with the first circuit board, and the microphone is arranged on the front face of the camera main body.

Further, a back face of the camera main body is provided with anti-skid pieces.

Further, the anti-skid pieces include first anti-skid pieces and second anti-skid pieces, the first anti-skid pieces get close to the top of the camera main body and are arranged on both sides of the back face of the camera main body, the second anti-skid pieces get close to the bottom of the camera main body and are arranged on both sides of the back face of the camera main body, a via hole is formed in the second anti-skid piece, and a second fixed part passes through the via hole so that the camera main body is fixed to a platform by the second fixed part.

Further, the first anti-skid pieces and the second anti-skid pieces include lugs and saw teeth, the lugs are fixedly arranged on the back face of the camera main body, the saw teeth are arranged on one side, away from the camera main body, of the lug, the saw teeth are used for abutting the platform, and the via hole is formed in the lug.

Further, a top surface of the solar device is slantly arranged relative to the camera main body.

Further, the bottom of the back face of the camera main body is provided with a mounting seat, a fourth mounting hole is formed in the mounting seat, close to the camera main body, and the fourth mounting hole is used for mounting a third fixed part so that the camera main body is fixed to the platform by the third fixed part. Further, a fifth mounting hole is formed in the top of the back face of the camera main body, and the fifth mounting hole is used for mounting a fourth fixed part so that the camera main body is fixed to the platform by the fourth fixed part.

Further, the hunting camera also includes an antenna, the antenna is arranged on one side of the camera main body and electrically connected with the control circuit board.

Beneficial effects: The present disclosure provides a hunting camera. Through the arrangement of the solar device, light energy is converted into electric energy by the solar device for supplying power for the hunting camera to reduce the situation of insufficiency in power supply. The hunting camera does not need to be disassembled frequently for battery replacement or charging. Through the integral arrangement of the solar device and the upper shell or the lower shell, the hunting camera is small and convenient for the user to carry. The gap between the upper shell and the lower shell is sealed by the sealing ring after the upper shell and the lower shell are closed, so that the hunting camera can be used in various environmental situations.

### BRIEF DESCRIPTION OF THE DRAWINGS

FIG. 1 is a front face space diagram of a hunting camera provided by the present disclosure.

FIG. 2 is a back face space diagram of FIG. 1 in another visual angle provided by the present disclosure.

FIG. 3 is an explosive view of a hunting camera provided by the present disclosure.

FIG. 4 is an explosive view of FIG. 3 in another visual angle provided by the present disclosure.

### DETAILED DESCRIPTION OF THE EMBODIMENTS

In order to make the aims, technical solution and advantages of the present disclosure will be clearly, the present disclosure is further described below in combination with accompanying drawings and implementations. It should be understood that the specific embodiments described herein are intended only to explain the present disclosure and are not intended to define the present disclosure.

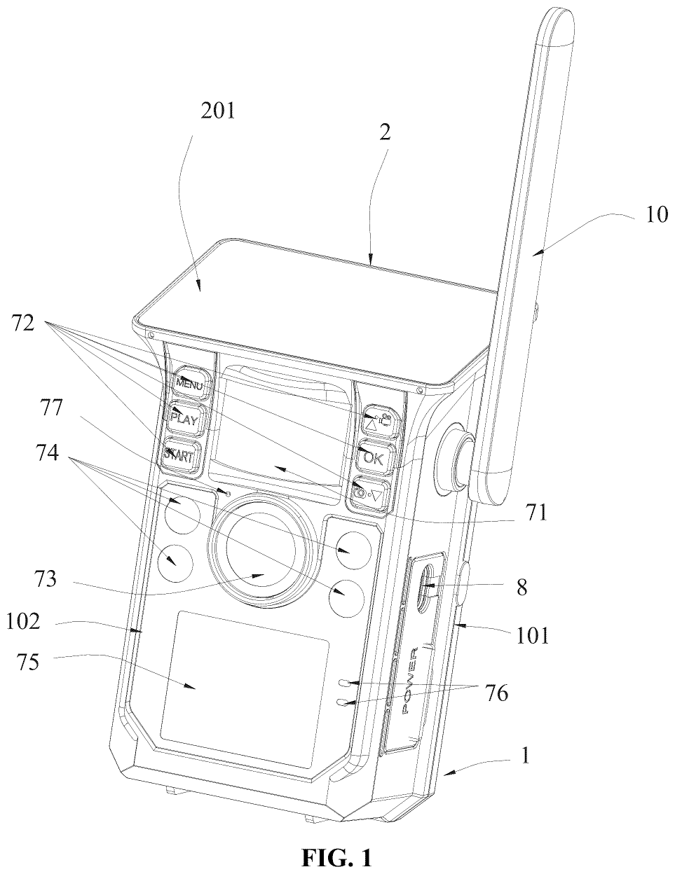

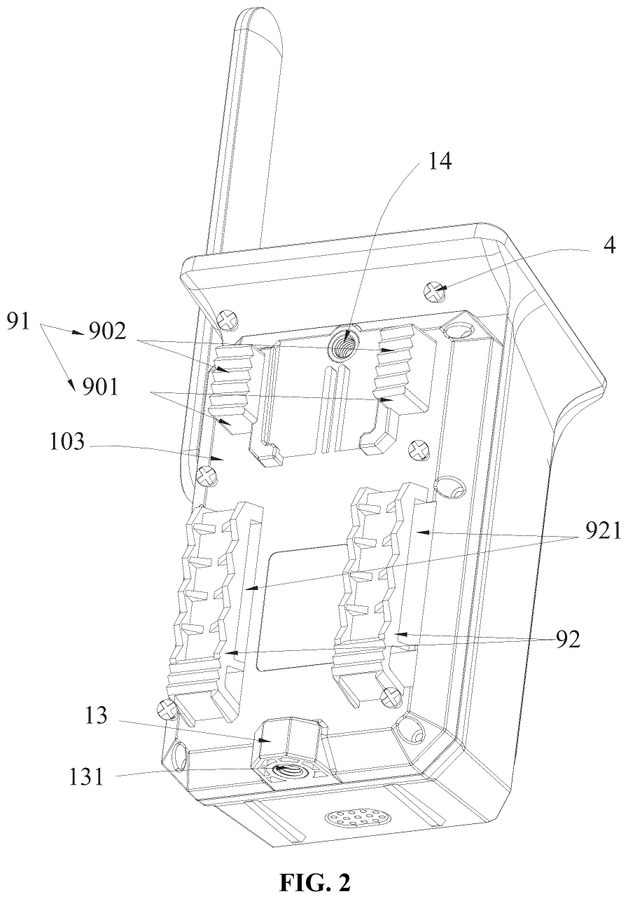

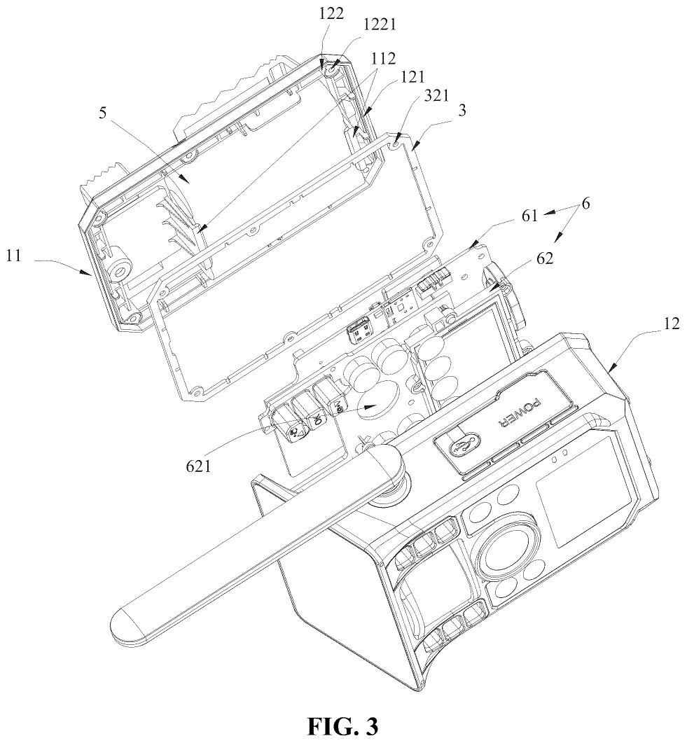

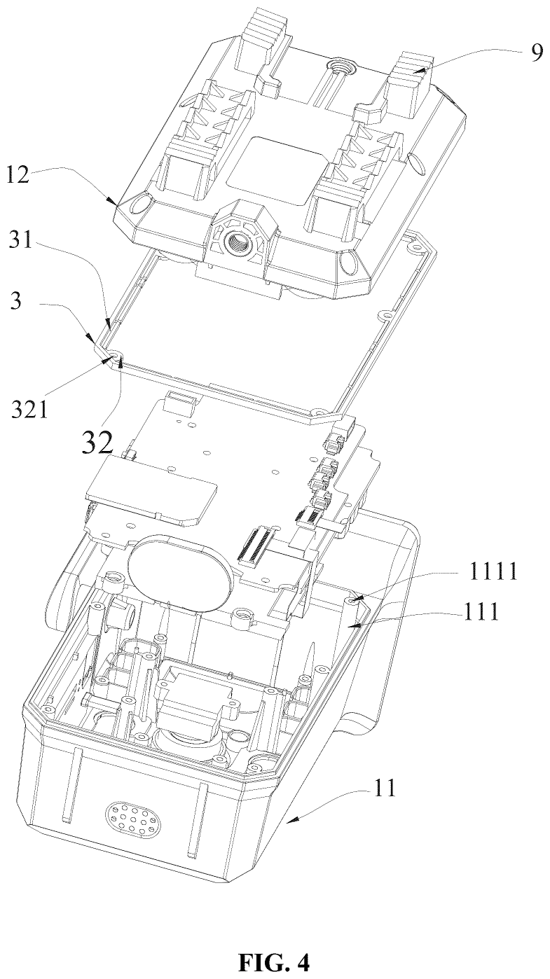

Referring to FIG. 1 to FIG. 4, a hunting camera is provided by the present disclosure. The hunting camera includes a camera main body 1, a solar device 2 and a sealing element 3. The camera main body 1 includes an upper shell 11 and a lower shell 12. The upper shell 11 and the lower shell 12 are fixedly closed. A previous gap 101 after the upper shell 11 and the lower shell 12 are closed is sealed by the sealing element 3 so as to form a sealing cavity after the upper shell 11 and the lower shell 12 are mutually closed. Components and parts inside the camera main body are protected, so that the hunting camera can be used no matter in rainy days or sunny days without the limitation of environmental situations. The upper shell 11 and the lower shell 12 are fixedly closed for preferable waterproof performance, and private disassembly of the user is prevented to protect the internal components and parts and prevent the user from blaming on merchants since the sealing of the sealing cavity cannot recovered after disassembly by the user to result failures in later use. The solar device 2 is arranged on the top of the upper shell 11 or the top of the lower shell 12, and the solar device 2 and the upper shell 11 or the lower shell 12 are integrally arranged, so that the hunting camera is small and convenient for the user to carry, and the solar device is also convenient to assemble and mount. That is to say, through the arrangement of the solar device, light energy is converted into electric energy by the solar device for supplying power for the hunting camera to reduce the situation of insufficiency in power supply. The hunting camera does not need to be disassembled frequently for battery replacement or charging. Through the integral arrangement of the solar device and the upper shell or the lower shell, the hunting camera is small and convenient for the user to carry. The gap between the upper shell and the lower shell is sealed by the sealing ring after the upper shell and the lower shell are closed, so that the hunting camera can be used in various environmental situations.

In the embodiment, the sealing element 3 is a sealing ring. The sealing ring is made of rubber material. A mounting groove 121 is formed in a side wall inside the upper shell 11 or the lower shell 12. The mounting groove 12 is arranged around an opening of the upper shell 11 or an opening of the lower shell 12. The sealing ring is mounted inside the mounting groove 121, and is in interference fit with a peripheral side wall of the mounting groove. A clamping groove 31 is formed in a side surface, facing towards the mounting groove 121, of the sealing ring. The clamping groove 31 is clamped to a side wall, away from the camera main body 1, of the mounting groove 121, so that the sealing ring is mounted more stably. Compared with the prior art, the sealing ring is directly mounted inside the mounting groove to achieve preferable sealing performance.

In the embodiment, the hunting camera also includes a first fixed part 4. First mounting columns 111 are arranged on the corners of the upper shell 11 internally. A first mounting hole 1111 is formed in an end head of one end, facing towards the lower shell 12, of the first mounting column 111. Second mounting columns 122 corresponding to the first mounting columns 111 are arranged inside the lower shell 122. A second mounting hole 1221 is formed in an end head of one end, facing towards the upper shell 12, of the second mounting column 122. The sealing ring is provided with connecting pieces 32 corresponding to the first mounting columns 111 and the second mounting columns 122. A third mounting hole 321 corresponding to the first mounting hole 1111 and the second mounting hole 1221 is formed in the connecting piece 32. The first fixed part 4 passes through the second mounting hole 1221, the third mounting hole 321 and the first mounting hole 1111 in sequence so that the lower shell 12 and the sealing ring are fixed to the upper shell 11. The structure is mainly used for stabler and firmer mounting of the upper shell, the lower shell and the sealing ring. Simple structures are convenient to assemble when leaving factories, and the first fixed part can be a bolt, a screw or a rivet or other components.

In the embodiment, the hunting camera also includes a storage battery 5. Supports 112 are arranged at both ends of an inner side surface of the upper shell 11. Both ends of the storage battery 5 are respectively placed on the two supports 112. The supports only need to bear the weight of both ends of the storage battery, so the supports only need to play a role in supporting the storage battery. Since the floor space of the battery is large, the overall volume of the hunting camera is large if the floor space of the battery is unreasonable in design, so that the hunting camera is bulky in appearance, and the user experience is reduced. If one large groove or large mounting rack is arranged for placing the storage battery, the volume of the hunting camera is increased. The support in the embodiment is small in floor space, and the battery is convenient to mount, so that the mounting space inside the sealing cavity is saved, the mounting of the sealing space becomes tight, and the volume of the hunting camera can be reduced.

In the embodiment, the hunting camera also includes a control circuit board 6. The solar device 2 and the storage battery 5 are both electrically connected with the control circuit board 6. The control circuit board 6 is arranged inside the sealing cavity. The control circuit board 6 is located below the storage battery 5 and gets away from the lower shell 12. The components inside the sealing cavity are mounted in order, so that the hunting camera is integrally small and convenient to carry.

In the embodiment, the hunting camera also includes a sensor 71, a plurality of functional buttons 72, a lens component 73, light components 74, a display screen 75 and an indicator light 76. The sensor 71, the functional buttons 72, the lens component 73, the light components 74, the display screen 75 and the indicator light 76 are all arranged on a front face 102 of the camera main body 1. The sensor 71, the lens component 73 and the display screen 75 are arranged towards the bottom of the camera main body 1 in sequence from approaching the top of the camera main body 1. The sensor is arranged on the top of the camera, so that dynamic objects can be sensed preferably. The lens is arranged in the middle, so that the hunting camera is coordinated and tidy in overall appearance. The display screen is arranged at the bottom, so that the overall arrangement is tidy, layered and not messy. The functional buttons 72 are distributed and arranged on both sides of the sensor 71. The light components 74 are distributed and arranged on both sides of the lens component 73, so that light is filled during lens shooting. The indicator light 76 is arranged on one side of the display screen. The indicator light is obvious, so that the state of the hunting camera is distinguished by the user conveniently. The indicator light can be used for display when files are transmitted, can be used for blinking display when the camera is started up, and also can be used for display after card-insertion connection. Certainly, the hunting camera can be provided with indicator lights but no display screens. Multiple indicator lights can be arranged for signal connection display, state display after the camera is started up, state display after card insertion and antenna signal intensity display.

In the embodiment, the control circuit board 6 includes a first circuit board 61 and a second circuit board 62. The first circuit board 61 and the second circuit board 62 are stacked and electrically connected. An opening 621 is formed in the second circuit board 62. One end of the lens component 73 is mounted on the first circuit board 61, and the other end of the lens component passes through the opening 621 to be mounted on the front face 101 of the camera main body 1. The functional buttons 72, the lens component 73, the light components 74, the display screen 75 and the indicator light 76 are connected with the first circuit board 61. The first circuit board 61 is mainly used for processing photographic images, and the second circuit board 62 is mainly used for accepting the processing of other functions.

In the embodiment, the hunting camera also includes a charging connector 8. The charging connector 8 is connected with the first circuit board 61. The charging connector 8 is located on a side surface of the camera main body 1. The charging connector is provided with a sealing cover unlabeled in figures, which is conventionally arranged without unnecessary details here.

In the embodiment, the hunting camera also includes a microphone 77. The microphone 77 is electrically connected with the first circuit board 61. The microphone 77 is arranged on a front face of the camera main body 1. The microphone mainly plays a role in collecting sound. How to collect sound by the microphone is in the prior art, and unnecessary details are not given here.

In the embodiment, a back face 103 of the camera main body 1 is provided with anti-skid pieces 9. When the hunting camera is bound on a certain platform, frictional force exists between the camera and the platform, and the hunting camera can hang on the platform for a long time to be prevented from falling off.

In the embodiment, the anti-skid pieces 9 include first anti-skid pieces 91 and second anti-skid pieces 92. The first anti-skid pieces 91 get close to the top of the camera main body 1 and are arranged on both sides of the back face of the camera main body 103. The second anti-skid pieces 92 get close to the bottom of the camera main body 1 and are arranged on both sides of the back face 103 of the camera main body. A via hole 921 is formed in the second anti-skid piece 92. A second fixed part passes through the via hole 921 so that the camera main body 1 is fixed to the platform by the second fixed part. The second fixed part can be a binding band, an iron wire or an elastic band, so that the hunting camera can be fixed to the platform through the via hole. If there is no through hole, the binding band is directly used. If the binding band is not tightened, the hunting camera is easy to fall off to be damaged. Through the structure, the anti-skid performance is higher, and the hunting camera is stabler when being mounted.

In the embodiment, the first anti-skid pieces 91 and the second anti-skid pieces 92 include lugs 901 and saw teeth 902. The lugs 901 are fixedly arranged on the back face of the camera main body 1. The saw teeth 902 are arranged on one side, away from the camera main body 1, of the lug 901. The saw teeth 902 are used for abutting the platform, and the via hole 921 is formed in the lug 901. The lug 901 is mainly used for increasing the height of the back face of the camera. The platform is rugged possibly, support points are needed, and the lug can be used for supporting to prevent from damaging and scraping the back face of the hunting camera. The saw teeth 902 mainly play a role in increasing the frictional force with the platform to prevent the hunting camera from falling down because of slipping when the hunting camera is fixed to the platform.

In the embodiment, a top surface 201 of the solar device 2 is slantly arranged relative to the camera main body 1 to preferably absorb sunlight.

In the embodiment, the bottom of the back face 103 of the camera main body 1 is provided with a mounting seat 13. A fourth mounting hole 131 is formed in a side surface, close to the bottom of the camera main body, of the mounting seat 13. The fourth mounting hole 131 is used for mounting a third fixed part so that the camera main body 1 is fixed to the platform by the third fixed part. That is to say, the mounting seat is arranged on the back face 103 of the camera main body 1, and the hunting camera can be vertically placed on the platform on which the hunting camera can be mounted through the third fixed part. The mounting seat 13 is not arranged at the bottom of the camera main body or one fourth mounting hole is directly arranged since the camera is inconvenient for the user to mount. Since the third fixed part can be long or short, the mounting seat 13 is arranged on the back face 103 of the camera main body 1 to facilitate the mounting of the user.

In the embodiment, a fifth mounting hole 14 is formed in the top of the back face 103 of the camera main body 1. The fifth mounting hole 14 is used for mounting a fourth fixed part so that the camera main body is fixed to the platform by the fourth fixed part 1. One more choice for fixing the hunting camera is made in case of need.

In the embodiment, the hunting camera also includes an antenna 10. The antenna 10 is arranged on one side of the camera main body 1 and electrically connected with the control circuit board 6. When the connection between a receiver and the hunting camera is weak, the antenna is used for receiving or strengthening signals. The antenna can intercept radio waves, so that less and smaller noise is generated during picture recording of the hunting camera, so that the user experience is improved. How to receive signals by the antenna is in the prior art, and unnecessary details are not given here.

In conclusion, the hunting camera in the embodiment is small, convenient to carry and waterproof, and is applicable to various environments. Moreover, the buttons convenient for the user to use, the display screen, the light components and the indicator lights are arranged, so that the user experience is improved.

It should be understood that the application of the present disclosure is not limited to the embodiments mentioned above. Those of ordinary skill in the art can obtain improvements or modifications based on the above descriptions. All such improvements and modifications should fall within the scope of protection of the claims of the present disclosure.

What is claimed is:

1. A hunting camera, comprising a camera main body, a solar device and a sealing element, wherein the camera main body comprises an upper shell and a lower shell, the upper shell and the lower shell are fixedly closed, a previous gap after the upper shell and the lower shell are closed is sealed by the sealing element so as to form a sealing cavity after the upper shell and the lower shell are mutually closed, the solar device is arranged on the top of the upper shell or the top of the lower shell, and the solar device and the upper shell or the lower shell are integrally arranged.

2. The hunting camera according to claim 1, wherein the sealing element is a sealing ring, a mounting groove is formed in a side wall inside the upper shell or the lower shell, the mounting groove is arranged around an opening of the upper shell or an opening of the lower shell, the sealing ring is mounted inside the mounting groove, a clamping groove is formed in a side surface, facing towards the mounting groove, of the sealing ring, and the clamping groove is clamped to a side wall, away from the camera main body, of the mounting groove.

3. The hunting camera according to claim 2, wherein the hunting camera also comprises a first fixed part, first mounting columns are arranged on the periphery of the upper shell internally, a first mounting hole is formed in an end head of one end, facing towards the lower shell, of the first mounting column, second mounting columns are arranged on the periphery of the lower shell internally and arranged corresponding to the first mounting columns, a second mounting hole is formed in an end head of one end, facing towards the upper shell, of the second mounting column, the sealing ring is provided with connecting pieces corresponding to the first mounting columns and the second mounting columns, a third mounting hole corresponding to the first mounting hole and the second mounting hole is formed in the connecting piece, and the first fixed part passes through the second mounting hole, the third mounting hole and the first mounting hole in sequence so that the lower shell and the sealing ring are fixed to the upper shell.

4. The hunting camera according to claim 1, wherein the hunting camera also comprises a storage battery, supports are arranged at both ends of an inner side surface of the upper shell, and both ends of the storage battery are respectively placed on the two supports.

5. The hunting camera according to claim 4, wherein the hunting camera also comprises a control circuit board, the solar device and the storage battery are both electrically connected with the control circuit board, the control circuit board is arranged inside the sealing cavity, and the control circuit board is located below the storage battery and gets away from the lower shell.

6. The hunting camera according to claim 5, wherein the hunting camera also comprises a sensor, a plurality of functional buttons, a lens component, light components, a display screen and an indicator light, the sensor, the functional buttons, the lens component, the light components, the display screen and the indicator light are all arranged on a front face of the camera main body, the sensor, the lens component and the display screen are arranged towards the bottom of the camera main body in sequence from approaching the top of the camera main body, the functional buttons are distributed and arranged on both sides of the sensor, the light components are distributed and arranged on both sides of the lens component, and the indicator light is arranged on one side of the display screen.

7. The hunting camera according to claim 6, wherein the control circuit board comprises a first circuit board and a second circuit board, the first circuit board and the second circuit board are stacked and electrically connected, an opening is formed in the second circuit board, one end of the lens component is mounted on the first circuit board, the other end of the lens component passes through the opening to be mounted on the front face of the camera main body, and the functional buttons, the lens component, the light components, the display screen and the indicator light are connected with the first circuit board.

8. The hunting camera according to claim 7, wherein the hunting camera also comprises a charging connector, the charging connector is connected with the first circuit board, and the charging connector is located on a side face of the camera main body.

9. The hunting camera according to claim 7, wherein the hunting camera also comprises a microphone, the microphone is electrically connected with the first circuit board, and the microphone is arranged on the front face of the camera main body.

10. The hunting camera according to claim 1, wherein a back face of the camera main body is provided with anti-skid pieces.

11. The hunting camera according to claim 10, wherein the anti-skid pieces comprise first anti-skid pieces and second anti-skid pieces, the first anti-skid pieces get close to the top of the camera main body and are arranged on both sides of the back face of the camera main body, the second anti-skid pieces get close to the bottom of the camera main body and are arranged on both sides of the back face of the camera main body, a via hole is formed in the second anti-skid piece, and a second fixed part passes through the via hole so that the camera main body is fixed to a platform by the second fixed part.

12. The hunting camera according to claim 11, wherein the first anti-skid pieces and the second anti-skid pieces comprise lugs and saw teeth, the lugs are fixedly arranged on the back face of the camera main body, the saw teeth are arranged on one side, away from the camera main body, of the lug, the saw teeth are used for abutting the platform, and the via hole is formed in the lug.

13. The hunting camera according to claim 1, wherein a top surface of the solar device is slantly arranged relative to the camera main body.

14. The hunting camera according to claim 1, wherein the bottom of the back face of the camera main body is provided with a mounting seat, a fourth mounting hole is formed in the mounting seat, and the fourth mounting hole is used for mounting a third fixed part so that the camera main body is fixed to the platform by the third fixed part.

15. The hunting camera according to claim 1, wherein a fifth mounting hole is formed in the top of the back face of the camera main body, and the fifth mounting hole is used for mounting a fourth fixed part so that the camera main body is fixed to the platform by the fourth fixed part.

16. The hunting camera according to claim 5, wherein the hunting camera also comprises an antenna, the antenna is arranged on one side of the camera main body and electrically connected with the control circuit board.
